(19) United States
(12) Patent Application Publication
(10) Pub. No.: US 2019/0255883 A1
(43) Pub. Date: Aug. 22, 2019

(54) STABILIZER PLY AS AN IMPACT BREAK DEFLECTOR IN TIRES

(71) Applicant: Bridgestone Americas Tire Operations, LLC, Nashville, TN (US)

(72) Inventors: James E. BRAESSLER, Streetsboro, OH (US); Pablo M. ROJAS, Franklin, TN (US)

(73) Assignee: Bridgestone Americas Tire Operations ,LLC, Nashville, TN (US)

(21) Appl. No.: 16/341,241

(22) PCT Filed: Nov. 7, 2017
(86) PCT No.: PCT/US2017/060265

§ 371 Date: Apr. 11, 2019

Related U.S. Application Data
(60) Provisional application No. 62/419,991, filed on Nov. 10, 2016.

(51) Int. Cl. B60C 1/00; B60C 9/06; B60C 9/00; C08K 3/36; C08K 3/04

(52) U.S. Cl. CPC B60C 1/00; B60C 9/06; B60C 9/0007; C08K 3/36; C08K 3/04; B60C 2200/14; C08K 2201/011; B60C 2200/06; B60C 2200/08; C08K 2201/014; C08K 2201/006; C08K 2201/005; B60C 2001/0066

(57) ABSTRACT

Rubber compositions are disclosed having a reinforcing filler of carbon black having select properties and a rubber, and tires and tire components and belt skims made from the rubber compositions. The rubber compositions can further include an additional reinforcing filler to form a blend of fillers. The rubber compositions are used to form belt assemblies having reinforcing components, such as metal cords. Also disclosed herein are methods of manufacturing belt assemblies and tires with belt assemblies disposed in the belt skim rubber compositions.

### TECHNICAL FIELD

The present invention relates to belt assemblies coated with a rubber composition and off-the-road tires including the same, and more particularly, metal belts disposed in a rubber belt skim and off-the-road tires including the same.

### BACKGROUND

Larger sized tires designed for off-the-road (OTR) applications (e.g., use in mines, agriculture, construction sites, etc.) with large-sized vehicles contain a significant amount of rubber material in the crown portion as compared to passenger tires. The OTR tires are often subject to severe service requirements for extended periods of time. For example, the OTR tires can be required to withstand heavy loads and travel over rough terrain such as debris, packed soil conditions, rocks, and broken concrete. Over time the tires deform and contract repeatedly as well as the increased rubber material generates high amounts of heat. As the tires gain more time in the severe service conditions, the repeated stresses on the tire and the high heat generated therein can lead to compromised tire performance such as separation of the rubber material forming the tread or belt portions from the belt layer, which decreases the service life of the tire.

Methods to address heat build-up and adhesion issues have included adjusting rubber compositions to form lower operating temperature portions having better adhesion to one another. Moreover, long cure times for OTR tires can pose drawbacks for certain belt materials and adhesion of the reinforcing materials to a rubber coating or belt skim. In use, a belt portion is incorporated into the tire to impart stiffness and can include a rubber material having a composition different than the tread portion and the base layer in the crown portion. The interface areas between the belt coating and reinforcement materials making up the belt form a potential weak point where cracks can form and propagate through the tire. For instance, the adhesion between the belt skim and a reinforcing material or belt assembly can decrease over the service life of the tire and thereby lead to separation of the layers. A decrease in the service life of an OTR tire reduces the return on investment in the tires and results in an increase in service maintenance and down time for a large vehicle.

It is an objective of the present disclosure to overcome one or more difficulties related to the prior art. A tire having improved adhesion between the belt and the belt skim coating the belt and underlying the tread and base layer portions can have a longer service life and increase return on investment for an OTR tire. It has been found that use of an improved belt skim composition to coat the belt layer can improve adhesion, which leads to a longer service life in the OTR tire.

### SUMMARY

In a first aspect, there is a pneumatic tire for off-the-road use that includes a belt having a reinforcing component, the reinforcing component being disposed in a belt skim, and the belt skim being composed of a rubber composition that includes rubber and a blend of reinforcing fillers, wherein the tire has an outside diameter of at least about 45 inches.

In an example of aspect 1, the reinforcing component is a metal material.

In another example of aspect 1, the reinforcing component is a plurality of metal cords.

In another example of aspect 1, the belt skim is in direct contact with the reinforcing component.

In another example of aspect 1, the blend of reinforcing fillers includes at least two fillers, wherein the two fillers are different from one another.

In another example of aspect 1, the rubber composition includes silica and carbon black.

In another example of aspect 1, the rubber composition includes 5 to 20 phr of silica and 20 to 50 phr of carbon black.

In another example of aspect 1, the rubber composition includes a carbon black to silica ratio of 5:1 to 3:1.

In another example of aspect 1, the carbon black has a nitrogen absorption specific surface area N₂SA of 70 to 90 m²/g and a dibutyl phthalate absorption DBPA of 80 to 120 ml/100 g.

In another example of aspect 1, the carbon black has a dibutyl phthalate absorption DBPA of 90 to 110 ml/100 g and a mean particle diameter of 25 to 40 nm.

In another example of aspect 1, the tire is a bias tire.

The first aspect may be provided alone or in combination with any one or more of the examples of the first aspect discussed above.

In a second aspect, there is a pneumatic tire for off-the-road use that includes a belt component, the belt component is coated with a belt skim composed of a rubber composition that includes rubber, greater than 20 phr of carbon black, and wherein the carbon black has a dibutyl phthalate absorption DBPA of greater than 80 ml/100 g and a mean particle diameter of 25 to 40 nm.

In an example of aspect 2, the rubber composition also includes less than 20 phr of silica.

In another example of aspect 2, the rubber composition also includes less than 6 phr of sulfur.

In another example of aspect 2, the tire has an outside diameter of at least about 45 inches.

In another example of aspect 2, the belt component includes a metal material.

In another example of aspect 2, the rubber composition includes a carbon black to silica ratio of 5:1 to 3:1.

In another example of aspect 2, the carbon black has a nitrogen absorption specific surface area N₂SA of 70 to 90 m²/g and a dibutyl phthalate absorption DBPA of 80 to 120 ml/100 g.

In another example of aspect 2, the tire is a bias tire.

The second aspect may be provided alone or in combination with any one or more of the examples of the second aspect discussed above, or with any one or more of the examples of the first aspect.

The accompanying drawings are included to provide a further understanding of principles of the invention, and are incorporated in and constitute a part of this specification. The drawings illustrate one or more embodiment(s), and together with the description serve to explain, by way of example, principles and operation of the invention. It is to be understood that various features disclosed in this specification and in the drawings can be used in any and all combinations. By way of non-limiting example the various features may be combined with one another as set forth in the specification as aspects.

### BRIEF DESCRIPTION OF THE DRAWINGS

The above description and other features, aspects and advantages are better understood when the following detailed description is read with reference to the accompanying drawings, in which:

FIG. 1 shows a cross-sectional view of an off-the-road tire taken along the tread width direction.

### DETAILED DESCRIPTION

The terminology as set forth herein is for description of the embodiments only and should not be construed as limiting the invention as a whole. Any reference to the “invention” may refer to one or more, but not necessarily all, of the inventions defined by the claims.

Herein, when a range such as 5-25 (or 5 to 25) or variable (e.g., 5) is given, for instance in the Example section or otherwise, this means preferably at least or more than 5 and/or, separately and independently, preferably not more than or less than 25. In an example, such a range defines independently at least 5, and separately and independently, not more than 25.

The term “phr” means parts per hundred parts of rubber by weight, and is a measure common in the art wherein components of a composition (e.g., belt skim) are measured relative to the total of all of the elastomer (rubber) components. The total phr or parts for all rubber components, whether one, two, three, or more different rubber components are present in a rubber composition are defined as 100 phr. Other non-rubber components are generally proportional to the 100 parts of rubber and the relative amounts may be expressed in phr.

The present disclosure relates to the use and incorporation of a belt or belt assembly made of a reinforcing component disposed in a belt skim rubber composition having improved tear resistance, crack growth prevention, resistance to heat degradation, toughness or a combination thereof. Preferably the belt is for use in off-the-road or OTR tires. Off-the-road or OTR tires are designed for harsh conditions and are large relative to passenger tires, for example, the OTR tires can have an overall outside diameter of at least 35, 40, 45, 50, 55, 60, 80, 100, 120, 140 or 160 inches. The OTR tires can be bias type or radial type depending on the desired service and performance characteristics. The increased size and cost of OTR tires, and the harsh service demands for the tires, make maximizing the length of tire service life advantageous. Compromised tire performance often includes separation, tears or cracks of component materials, for example a belt or belt portion from a belt skim, within the tire and thus improved strength and resistance to degradation of materials can extend the service life of the tire. The belt skim rubber composition of the present disclosure can enhance the OTR performance over its life and resist compromised performance around the belt reinforcing components.

By containing one or more reinforcing fillers in the belt skim that contacts the reinforcing component, the belt skim composition can have improved tear strength and degradation resistance. For example, the belt can be made of a rubber composition having a blend of reinforcing fillers in contact with one or more reinforcing components such as a plurality of metal cords. A reinforcing filler of the belt skim can be selected as carbon black having at least one characteristic that enhances the belt skim's properties, for example, tear strength or resistance to degradation. Selected carbon black can be further blended with other different reinforcing fillers, for instance, silica.

In one or more embodiments, the belt skim is made from a rubber composition that contains a blend of reinforcing fillers or at least one reinforcing filler having a select characteristic or property. A reinforcing filler can be carbon black and have a nitrogen specific surface area N₂SA in the range of 70 to 90 m²/g, 70 to 80 m²/g or less than 85, 80 or 75 m²/g. In another embodiment, the reinforcing filler has a dibutyl phthalate absorption of 80 to 120 ml/100 g, 90 to 110 ml/100, or at least 85, 90, 95 or 100 ml/100. In yet another embodiment, the reinforcing filler has a 300% elongation stress of 0.1 to 1 MPa, 0.2 to 0.8 MPa, or less than 0.8, 0.7, 0.6 or 0.5 MPa. In another embodiment, the reinforcing filler has a mean particle diameter of 25 to 40 nm, 28 to 36 nm or less than 35 or 30 nm. A reinforcing filler can be selected that has one or more of the above characteristics and, for example, all of the noted properties or various combinations thereof.

In one or more embodiments, the belt skim is made from a composition that has a total reinforcing filler content in an amount of 30 to 80 phr, 35 to 65 phr, or 40, 45, 50, 55 or 60 phr. The reinforcing filler content in the belt skim composition can include more than one reinforcing filler, for example, at least two fillers, e.g., a first reinforcing filler and a second reinforcing filler. The first and second reinforcing fillers can be different from one another. The first reinforcing filler (e.g., carbon black) can be present in an amount in the range of 20 to 60 phr, 30 to 50 phr, or 35, 40 or 45 phr. The second reinforcing filler (e.g., silica) can be present in an amount in the range of 1 to 40 phr, 5 to 30 phr, 10 to 20 phr, or 15 phr.

A blend of reinforcing fillers can be present in the belt skim composition in a select weight percent or phr ratio, for example, a first reinforcing filler (e.g., carbon black) can be present in a phr ratio to a second reinforcing filler (e.g., silica) in a range of 5:1 to 3:1, 4.5:1 to 3.5:1 or 4:1.

The blend of reinforcing fillers can include silica in addition to carbon black. Examples of reinforcing silica fillers which can be used include wet silica (hydrated silicic acid), dry silica (anhydrous silicic acid), calcium silicate, and the like. Among these, precipitated amorphous wet-process, hydrated silicas are preferred. Silica can be employed in an amount of 1 to 40 phr, 5 to 30 phr, 10 to 20 phr, or 15 phr. The useful upper range is limited by the high viscosity imparted by fillers of this type. Some of the commercially available silicas which can be used include, but are not limited to, HiSil 190, HiSil 210, HiSil 215, HiSil 233, HiSil 243, and the like, produced by PPG Industries (Pittsburgh, Pa.). A number of useful commercial grades of different silicas are also available from DeGussa Corporation (e.g., VN2, VN3), Rhone Poulenc (e.g., Zeosil 1165 MPO), and J. M. Huber Corporation.

The surface of the carbon black and/or silica may optionally be treated or modified to improve the affinity to particular types of polymers. Such surface treatments and modifications are well known to those skilled in the art.

Additional fillers may also be utilized, including but not limited to, mineral fillers, such as clay, talc, aluminum hydrate, aluminum hydroxide and mica. The foregoing additional fillers are optional and can be utilized in varying amounts from 0.5 phr to 40 phr.

The belt skim can include a coupling agent, for example silane, when silica or some other type of inorganic particles are used as the filler. In such embodiments, the silane coupling agent can help aid bonding of the filler (e.g., silica) to the elastomer. Examples of suitable silane coupling agents include, but are not limited to, functionalized polysulfide silanes, organosulfide polysulfides and organoalkoxymercaptosilanes, bis(trialkoxysilylorgano) polysulfide silanes and thiocarboxylate functional silanes. The amount of coupling agent in the belt skim composition can be based on the weight of the silica in the composition, and may be from about 0.1% to about 20% by weight of silica, from about 1% to about 15% by weight of silica, or alternatively from about 1% to about 10% by weight of silica. In another example, the coupling agent can be present in the belt skim in the range of 0.1 to 2 phr, 0.3 to 1.2 phr or 0.4, 0.5, 0.6, 0.7, 0.8, 0.9, 1 or 1.1 phr.

The belt skim includes a rubber composition having a unique reinforcing filler or filler blend as described herein. The rubber composition includes rubber or a rubber mixture, which may also be referred to as a vulcanizable composition. The rubber content of the composition can include 100 phr of rubber, which includes at least one rubber. The total amount of all rubbers is considered to be 100 parts (by weight) and is denoted 100 phr.

Both synthetic and natural rubber may be employed within the rubber compositions of the belt skim. These rubbers, which may also be referred to as elastomers, include, without limitation, natural or synthetic poly(isoprene) with natural polyisoprene being preferred, and elastomeric diene polymers including polybutadiene and copolymers of conjugated diene monomers with at least one monoolefin monomer. Suitable polybutadiene rubber is elastomeric and has a 1,2-vinyl content of about 1 to 3 percent and a cis-1,4 content of about 96 to 98 percent. Other butadiene rubbers, having up to about 12 percent 1,2-content, may also be suitable with appropriate adjustments in the level of other components, and thus, substantially any high vinyl, elastomeric polybutadiene can be employed. The copolymers may be derived from conjugated dienes such as 1,3-butadiene, 2-methyl-1,3-butadiene-(isoprene), 2,3-dimethyl-1,2-butadiene, 1,3-pentadiene, 1,3-hexadiene and the like, as well as mixtures of the foregoing dienes. The preferred conjugated diene is 1,3-butadiene.

Regarding the monoolefinic monomers, they include vinyl aromatic monomers such as styrene, alpha-methyl styrene, vinyl naphthalene, vinyl pyridine and the like as well as mixtures of the foregoing. The copolymers may contain up to 50 percent by weight of the monoolefin based upon total weight of copolymer. The preferred copolymer is a copolymer of a conjugated diene, especially butadiene, and a vinyl aromatic hydrocarbon, especially styrene. Preferably, the rubber compound can comprise up to about 35 percent by weight styrene-butadiene random copolymer, preferably 15 to 25 percent by weight.

The above-described copolymers of conjugated dienes and their method of preparation are well known in the rubber and polymer arts. Many of the polymers and copolymers are commercially available. It is to be understood that practice of the present invention is not to be limited to any particular rubber included hereinabove or excluded.

The rubber polymers used in the belt skim composition can comprise either 100 parts by weight of natural rubber, 100 parts by weight of a synthetic rubber or blends of synthetic rubber or blends of natural and synthetic rubber such as 75 parts by weight of natural rubber and 25 parts by weight of polybutadiene. Polymer type, however is not deemed to be a limitation to the practice of the instant invention.

The reinforcing fillers (e.g., particles) are preferably well dispersed in the belt skim rubber composition, for example, by mixing the fillers with components of the rubber composition. The mixing or stirring conditions may be appropriately selected so as to form a uniform distribution of the filler particles in the rubber composition. For example, the rubber compositions according to the invention can be obtained by mixing the rubbers with the filler particles and other components, rubber auxiliaries or the like in conventional mixers, such as rollers, internal mixers and mixing extruders.

The belt skim composition can include other ingredients as known in the art as additives customarily included in rubber compositions for manufacturing tires, for example, such as mixing the various constituent rubbers with various commonly used additive materials such as, for example, sulfur, sulfur donors, peroxides, curing aids, such as accelerators, activators and retarders and processing additives, such as oils, resins including adhesive or tackifying resins and plasticizers, fillers, pigments, fatty acid, zinc oxide, waxes, anti-degradants such as antioxidants and anti-ozonants and peptizing agents. As known to those skilled in the art the additives mentioned above are selected and commonly used in conventional amounts. Conventional quantities are e.g. quantities of 0.1 to 200 phr.

In one or more embodiments, the belt skim rubber composition can include a curative or cure package. A cure package can include, for example, at least one of: a vulcanizing agent; a vulcanizing accelerator; a vulcanizing activator (e.g., zinc oxide, stearic acid, and the like); a vulcanizing inhibitor, and/or an anti-scorching agent. In certain embodiments, the cure package includes at least one vulcanizing agent, at least one vulcanizing accelerator, at least one vulcanizing activator and optionally a vulcanizing inhibitor and/or an anti-scorching agent. Vulcanizing accelerators and vulcanizing activators act as catalysts for the vulcanization agent. Vulcanizing inhibitors and anti-scorching agents are known in the art and can be selected by one skilled in the art based on the vulcanizate properties desired.

In one example, the belt skim composition may comprise zinc oxide in an amount of 0.1 to 10 phr, from 1 to 7 phr, or from 2 to 5 phr. In other examples, vulcanizing agents and vulcanization accelerators may also be added to the belt skim rubber composition. Suitable vulcanizing agents and vulcanization accelerators are known in the art, and may be added in appropriate amounts based on the desired physical, mechanical, and cure rate properties of the belt skim rubber composition. Examples of vulcanizing agents include sulfur and sulfur donating compounds. The amount of the vulcanizing agent used in the rubber composition may, in certain embodiments, be from 0.1 to 10 phr, or from 1 to 8 phr or less than 7, 6 or 5 phr.

When utilized, the particular vulcanization accelerator is not particularly limited. Numerous accelerators are known in the art and include, but are not limited to, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), 2-(morpholinothio)benzothiazole (MBS), N-tert-butyl-2-benzothiazole sulfonamide (TBBS), N-cyclohexyl-2-benzothiazole sulfonamide (CBS), and mixtures thereof.

The belt skim rubber composition can include at least one anti-degradant to protect the rubber from oxidative attack. Anti-degradants can include an antioxidant or anti-ozonant, and the belt skim composition can include an AO package of at least one anti-degradant. Anti-degradants can include, for example, p-phenylenediamines (PPDs), such as N-(1,3-dimethylbutyl)-N′-phenyl-p-phenylenediamine (6PPD), trimethyl-dihydroquinolines (TMQs), phenolics, alkylated diphenylamines (DPAs), aromatic phosphites, and diphenylamine-ketone condensates or combinations thereof. The anti-degradants or combination of anti-degradants can be present in the rubber composition in a range of 0.5 and 10 phr, 1 and 8 phr or less than 7, 6, 5, 4 or 3 phr.

In one embodiment, the belt skim composition can include one or more adhesion promoters generally used for metal belt structures. Metal adhesion promoters are known in the art and can include, for example, metal compound or salt type, in particular cobalt, nickel or lanthanide salts and compounds. The metal salts are employed to improve initial adhesiveness between the coating rubber and the metal reinforcing materials in direct vulcanization adhesion generally used for tires and the like.

The belt skim rubber compositions may be formed by mixing the ingredients together by methods known in the art, such as, for example, by kneading the ingredients together in a Banbury mixer. For example, the composition may be mixed in at least two mixing stages. The first stage may be a mixing stage where no vulcanizing agents or vulcanization accelerators are added, commonly referred to by those skilled in the art as a non-productive mixing stage. In certain embodiments, more than one non-productive mixing stage may be used. The final stage may be a mixing stage where the vulcanizing agents and vulcanization accelerators are added, commonly referred to by those skilled in the art as a productive mixing stage. The non-productive mixing stage(s) may be conducted at a temperature of 130° C. to 200° C. The productive mixing stage may be conducted at a temperature below the vulcanization temperature in order to avoid unwanted pre-cure of the rubber composition. Therefore, the temperature of the productive mixing stage should not exceed 120° C. and is typically 40° C. to 120° C., or 60° C. to 110° C. and, especially, about 75° C. to 100° C.

The belt structure or reinforcing components disposed in or having portions covered by the belt skim can be further processed as known in the art to produce a tire containing the belt. The tire can have one, two or three belt plies as reinforcing components, for example, made of metal or non-metal reinforcing components disposed in the belt skim. The assembled tire components containing the reinforcing components can be vulcanized or cured to produce an off-the-road tire. In one or more embodiments, vulcanization can be effected by heating the vulcanizable composition within a mold. In one or more embodiments, the composition can be heated at a temperature from 140° C. to 180° C. for a period of 2 to 30 hours. The increased amount of material in an off-the-road tire (e.g., in the crown portion) as compared to a passenger vehicle tire can require longer cure times in excess of more than 2 hours, more than 4 hours, more than 6 hours or more than 8 hours or greater. The increased exposure time to elevated temperature (e.g., above at least 120° C.) can generate increased stress on the rubber compositions and other tire components and reduce toughness (tensile strength, TB×elongation, EB), crack growth resistance, degradation, and combinations thereof. The belt skim compositions of the present disclosure improve one or more of the properties affected by the increased cure times used for manufacturing off-the-road tires.

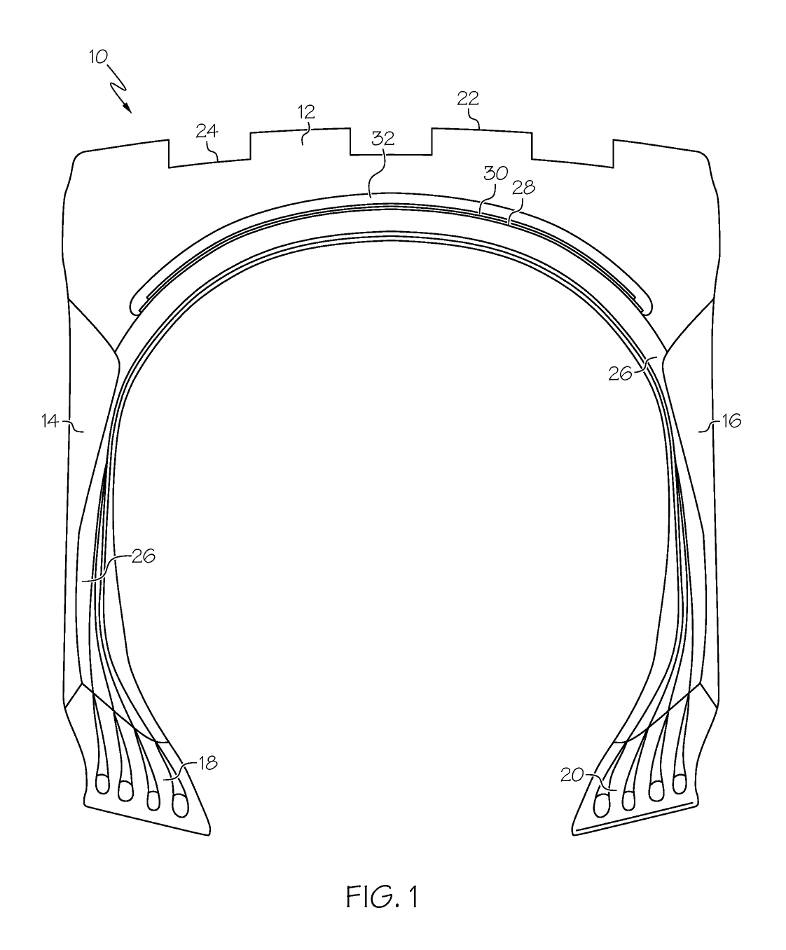

An example of a tire 10 according to the present disclosure is shown in FIG. 1. The tire 10 can be an off-the-road pneumatic tire. The tire 10 includes a circumferential tread or tread portion 12, first and second sidewalls or sidewall portions 14 and 16, and first and second beads or bead portions 18 and 20. The tread portion 12 includes a plurality of lugs 22 having a ground-contacting surface extending upward from a tread floor 24.

The off-the-road tires utilizing the present design are also relatively large tires which have outside diameters in a range of from about 35 to about 160 inches. The design is especially useful on the very large tires having outside diameters of greater than about 45 inches.

A carcass 26 includes a plurality of carcass plies, sometimes also referred to as body plies. In the embodiment illustrated, the carcass 26 includes four carcass plies. In general, the carcass 26 may include from two to six carcass plies. Each of the carcass plies extends circumferentially about the tire. The carcass plies each can include an axially inner portion and axially outer portions that extend around the bead portions and extend upwardly toward the tread portion and terminate at turn-up ends. The carcass plies may be nylon cord reinforced carcass plies.

A plurality of circumferentially extending reinforcing components, shown as belts 28, 30, are disposed between the carcass 26 and the tread portion 12 or under layer if present. The reinforcing components (e.g., a belt assembly) can provide lateral stiffness across the belt area width and reduce lifting of the tread portion 12 from the road surface during rolling. In certain embodiments, the reinforcing components may be in different forms, for example, a unitary cord (unit cord), a film (e.g., a strip or band), a multitude of cords that can be twisted together (e.g., a cable) or generally parallel to one another (e.g., a bundle of cords or assembly of fibers). The reinforcing component, for example cords, can be oriented at any desirable angle with respect to the mid-circumferential center-plane of the tire 10, for instance, in the range of 18 to 26 degrees. In the embodiment that two belts are present in the tire, for example, belts 28, 30, the reinforcing components can be oriented in opposite directions from another ply layered above or below. The one or more belts, e.g., 28, 30, can be single cut layers, and preferably do not have folded lateral edges.

As shown, the belt skim 32 overlies and does not encase the one or more belts of the tire 10. In one embodiment the plurality of belts can include from two to eight belts, or four or six belts. The belts may be Nylon, aramid or metal cord reinforced belts. The belts may be biased in alternating layers, for instance, in a range of from about 69° to 77° to the rotational axis of the tire. In one or more embodiments, the belt skim 32 can completely encase or enclose the one or more belts of the tire 10, for example, belts 28, 30.

In another embodiment the tire may have two steel reinforced belts and from two to six fabric reinforced radial carcass plies. In still another embodiment the tire may have two steel reinforced belts and one steel reinforced radial carcass ply.

The belts have axial end edges, which can be staggered to create a tapered edge on the package of belts. A belt edge insert (not shown) can extend under the edge of the belts, and also extends downward into the sidewall portion. The belt edge insert can serve to hold the axially outer portions of the belts in a substantially horizontal orientation so that they do not follow the downward curve of the carcass.

A belt skim 32 is located between the circumferential tread portion 12 and the belts 28, 30. In the embodiment of FIG. 1 it is seen that the belt skim 32 extends to an axial edge minimally beyond the axial edges of the belts. Alternatively, the axial edge of skim 32 can extend well beyond the belt edges. As shown, the belt skim 32 is in contact with the tread portion 12 and belts 28, 30. Preferably there is no intermediate layer or other coating arranged between the reinforcing components and/or multiple reinforcing components and the belt skim.

The belt skim rubber composition preferably exhibits an improved stress strain profile as compared to a belt skim composition that excludes one or the blend of reinforcing fillers of the present disclosure. The stress strain profile can include measuring the modulus, break elongation and tensile strength of a rubber composition sample at aged and unaged sample conditions. In an unaged sample (thermal treatment over a period of time), the overall stress strain profile, here referred to as the average of 200% modulus, elongation at break percent (EB or Eb) and tensile strength (TB or Tb) of the belt skim rubber composition sample, can be measured at 25° C. after the rubber composition is formed. In an example, the toughness (MPa) of the belt skim composition, measured as TB multiplied by EB, can be greater than 9,000, greater than 9,500, greater than 9,800 or greater than 10,000 MPa.

In other examples, the crack growth resistance of the belt skim composition, as measured by ASTM D412 Die C, can be greater than 50,000, greater than 60,000, greater than 70,000 or greater than 80,000 cycles at a 100% strain at 25° C. in an unaged sample. In another example, the crack growth resistance of the belt skim composition, as measured by ASTM D412 Die C, can be greater than 500, greater than 1,000, greater than 1,500, greater than 2,000 or greater than 2,500 cycles at a 100% strain after aging the composition for 2 days at 100° C. in an oven.

In order to demonstrate the practice of the present invention, the following examples have been prepared and tested. The examples should not, however, be viewed as limiting the scope of the invention. Numerous variations over these specific examples are possible without departing from the spirit and scope of the presently disclosed embodiments. More specifically, the particular rubbers, fillers, and other ingredients (e.g., curative package ingredients) utilized in the following examples should not be interpreted as limiting since other such ingredients consistent with the disclosure in the Detailed Description can be utilized in substitution. In other words, the particular rubbers, fillers, and other ingredients as well as their amounts and their relative amounts in the following examples should be understood to apply to the more general content of the Detailed Description.

### Example 1

General Experimental Testing Procedures

Modulus, Tensile Strength and Elongation at Break

Modulus, Tensile Strength (Stress at Maximum Strain) and Elongation at Break are measured generally according to ASTM D 412. The measurements for the above properties are based on the original cross sectional area of the test specimen. An instrument equipped to produce a uniform rate of grip separation, such as an Instron tensile tester, with a suitable dynamometer and an indicating or recording system for measuring applied force is used in conjunction with a measurement of extension of the test specimen. Modulus (200% (M200)), tensile strength (TB) MPa and elongation (EB) are calculated according to the calculations set forth in ASTM D412.

Comparative Example A (Comp. A) was representative of a carbon black filled rubber composition, wherein the carbon black was present at 49 phr and has a nitrogen specific surface area N₂SA of about 72 m²/g, a dibutyl phthalate absorption of 82 ml/100 g and a 300% elongation stress of 3.5 MPa. The carbon black in Comp. A is indicated as Carbon Black 1 in Table 1. Comp. A was compared to a rubber composition containing a blend of 40 phr carbon black and 10 phr silica, wherein the carbon black has a nitrogen specific surface area N₂SA of about 102 m²/g, a dibutyl phthalate absorption of 82 ml/100 g and a 300% elongation stress of 0.5 MPa. The carbon black in Exp. 1 is indicated as Carbon Black 2 in Table 1. Table 1 contains the formulation for each of Comparative Example A (Comp. A) and Experimental Example 1 (Exp. 1). All material amounts in Table 1 are shown in phr.

TABLE 1

| Material | Comp. A | Exp. 1 |
|---|---|---|
| Rubber | 100 | 100 |
| Carbon Black 1 | 49 | 0 |
| Carbon Black 2 | 0 | 40 |
| Silica | 0 | 10 |
| Coupling agent | 0 | 0.8 |
| Vulcanizing Activator | 8.25 | 8.25 |
| Antidegradants | 2.3 | 2.3 |
| Sulfur | 6.5 | 4.7 |
| Accelerator | 0.54 | 0.8 |
| Adhesion promoter | 0.56 | 0.56 |

Properties of Comp. A and Exp. 1 compositions were measured and shown below in Table 2.

TABLE 2

| | Comp. A | Exp. 1 |
|---|---|---|
| EB | 420 | 457 |
| TB | 21.2 | 21.5 |
| M200 | 7.64 | 6.88 |
| TB × EB | 8,936 | 9,808 |

The composition of Exp. 1 exhibited an increase in toughness (TB×EB) of 9.76 percent as compared to Comp. A. Stress-strain data comparing the two compositions at various test conditions is shown below in Table 3. As the data confirms, the composition of Exp. 1 exhibited an increased resistance to heat degradation as compared to the composition of Comp. A. For instance, the composition of Exp. 1 exhibited a decrease in % Stress (MPa) at a variable Strain % as recited in the last column of Table 3.

TABLE 3

| | Comp. A | Exp. 1 | % Decrease |
|---|---|---|---|
| Test Condition | (Strain %/Stress MPa) | (Strain %/Stress MPa) | in Stress |
| 50 minutes at 150° C., | 50/1.66 | 50/1.53 | 7.8 |
| 25° C. | 300/13.62 | 300/12.35 | 9.3 |
| | 420.47/21.25 | 457.23/21.45 | |
| 50 minutes at 150° C., | 50/1.58 | 50/1.23 | 22.2 |
| 100° C. | 300/9.57 | 300/7.32 | 23.5 |
| | 393.69/13.03 | 400/10.38 | |
| | | 557.57/15.28 | |
| 50 minutes at 150° C., | 50/3.43 | 50/3.12 | 9.0 |
| 2 days at 100° C., 25° C. | 137.67/10.11 | 200/13.59 | |
| | | 207.92/14.00 | |
| 50 minutes at 150° C., | 50/2.54 | 50/2.16 | 15.0 |
| 2 days at 100° C., 25° C. | 102.47/5.05 | 200/8.03 | |
| | | 208.82/8.37 | |

Crack growth resistance data comparing the two compositions at various test conditions is shown below in Table 4. The data in Table 4 was generated from samples of each composition having a sample geometry as an ASTM D412 Die C dumbbell further having a modification of a 0.5 mm hole in the center. 25 mm gauge length was used to set initial strain and samples were cycled at 240 rpm until the sample broke and then the cycle count was recorded. As the data confirms, the composition of Exp. 1 exhibited an increased crack growth resistance to heat degradation and cycling as compared to the composition of Comp. A. For instance, the composition of Exp. 1 exhibited a cycle increase and increase in % cycle as recited in the last column of Table 4.

TABLE 4

| | Comp. A | Exp. 1 | Cycle Increase/ |
|---|---|---|---|
| Test Condition | (Strain %/Cycle) | (Strain %/Cycle) | % Increase |
| 25° C. | 100/10,517 | 100/81,278 | 70,761/673 |
| | 85/18,801 | 85/143,917 | 125,116/665 |
| | 70/103,273 | 70/295,194 | 191,921/186 |
| | 60/217,177 | 60/604,036 | 386,859/178 |
| Aged 2 days at | 100/117 | 100/2,720 | 2,603/2225 |
| 100° C. | 85/1,032 | 85/3,776 | 2,744/266 |
| | 70/1,769 | 70/6,329 | 4,560/258 |
| | 60/2,004 | 60/7,923 | 5,919/295 |

As shown in Table 4, the Exp. 1 sample exhibited at least a 150% cycle increase over a Strain % range of 60 to 100 as compared to Comp. A when tested at 25° C. After aging the samples for 2 days at 100° C. in an oven, the Exp. 1 sample exhibited at least a 250% increase over a Strain % range of 60 to 100 as compared to Comp. A.

All references, including but not limited to patents, patent applications, and non-patent literature are hereby incorporated by reference herein in their entirety.

While various aspects and embodiments have been disclosed herein, other aspects and embodiments will be apparent to those skilled in the art. The various aspects and embodiments disclosed herein are for purposes of illustration and are not intended to be limiting.

1. An off-the-road pneumatic tire comprising:
a belt comprising a reinforcing component, the reinforcing component being disposed in a belt skim, the belt skim being composed of a rubber composition comprising rubber and a blend of reinforcing fillers, wherein the tire has an outside diameter of at least about 45 inches.

2. The off-the-road pneumatic tire of claim 1, the reinforcing component being a metal material.

3. The off-the-road pneumatic tire of claim 1, the reinforcing component being a plurality of metal cords.

4. The off-the-road pneumatic tire of claim 1, the belt skim being in direct contact with the reinforcing component.

5. The off-the-road pneumatic tire of claim 1, the blend of reinforcing fillers comprising at least two fillers, the two fillers being different from one another.

6. The off-the-road pneumatic tire of claim 1, the rubber composition comprising silica and carbon black.

7. The off-the-road pneumatic tire of claim 6, the rubber composition comprising 5 to 20 phr of the silica.

8. The off-the-road pneumatic tire of claim 6, the rubber composition comprising 20 to 50 phr of the carbon black.

9. The off-the-road pneumatic tire of claim 6, the rubber composition comprising a carbon black to silica ratio of 5:1 to 3:1.

10. The off-the-road pneumatic tire of claim 6, the carbon black has a nitrogen absorption specific surface area N₂SA of 70 to 90 m²/g and a dibutyl phthalate absorption DBPA of 80 to 120 ml/100 g.

11. The off-the-road pneumatic tire of claim 10, the carbon black has a dibutyl phthalate absorption DBPA of 90 to 110 ml/100 g and a mean particle diameter of 25 to 40 nm.

12. The off-the-road pneumatic tire of claim 1, the tire being a bias tire.

13. An off-the-road pneumatic tire comprising a belt component, the belt component being coated with a belt skim composed of a rubber composition comprising rubber, greater than 20 phr of carbon black, the carbon black has a dibutyl phthalate absorption DBPA of greater than 80 ml/100 g and a mean particle diameter of 25 to 40 nm.

14. The off-the-road pneumatic tire of claim 13, the rubber composition further comprising less than 20 phr of silica.

15. The off-the-road pneumatic tire of claim 13, the rubber composition further comprising less than 6 phr of sulfur.

16. The off-the-road pneumatic tire of claim 13, the tire having an outside diameter of at least about 45 inches.

17. The off-the-road pneumatic tire of claim 13, the belt component comprising a metal material.

18. The off-the-road pneumatic tire of claim 13, the rubber composition comprising a carbon black to silica ratio of 5:1 to 3:1.

19. The off-the-road pneumatic tire of claim 13, the carbon black has a nitrogen absorption specific surface area N₂SA of 70 to 90 m²/g and a dibutyl phthalate absorption DBPA of 80 to 120 ml/100 g.

20. The off-the-road pneumatic tire of claim 13, the tire being a bias tire.
